(19) United States
(12) Patent Application Publication
(10) Pub. No.: US 2010/0072762 A1
(43) Pub. Date: Mar. 25, 2010

(54) Lockset

(75) Inventor: George R. Marks, Roslyn, NY (US)

Correspondence Address: LAW OFFICES OF JOHN R. MUGNO, 350 BROADWAY - 10TH FLOOR, NEW YORK, NY, 10013, US

(73) Assignee: Marks USA I, LLC, Amityville, NY (US)

(21) Appl. No.: 12/235,219

(22) Filed: Sep. 22, 2008

(51) Int. Cl. E05B 1/02

(52) U.S. Cl. 292/336.3; 16/414

(57) ABSTRACT

A lockset for a door has knobs which are generally conical in shape and tapered inwardly with distance from the door surface to prevent attachment of a noose. Finger receiving concavities are provided circumferentially about the inward tapering surface of the knob to facilitate grasping without providing any projection about which a noose can be secured. One or both knobs of the lockset can optionally be provided with a handle at its pistol end from the door which can be grasped between fingers to further enhance gripping ability while avoiding the provision of a projection to which a noose can be attached.

### BACKGROUND OF THE INVENTION

The present invention is directed to an improved lockset of the type commonly used for latching and opening a door. More specifically, the invention is provides a lockset having knobs which can be securely grasped and turned by one who is infirm in order to release a door latch but on which a noose cannot be securely tied.

Psychiatric patients have been known to attempt suicide by hanging while in hospitals or other psychiatric institutions. Hanging is sometimes accomplished by passing a noose formed from a bed sheet, dressing gown, shoe lace, dental floss, or other readily available elongated flexible object available to the patient, to a fixture from which the patient may be hanged.

Although rooms at psychiatric institutions are, to the extent possible, kept free of fixtures to which a noose can be attached, virtually every room has a door and door handle for opening and closing the door. Moreover, furniture in such rooms sometimes is equipped with handles. Such door knobs or handles are commonly of a configuration which permits a noose to be secured to them with sufficient stability to support the weight of a patient and, thereby, enable asphyxiation of the patient by hanging.

Psychiatric patients who may be inclined to commit hanging are often elderly and/or arthritic, and have difficulty grasping a door or drawer knob. The goals of providing a door knob or drawer knob configured to prevent attachment of a noose and that of making the door knob or drawer knob easily graspable by the patient who may have limited physical capacity to turn a knob are at odds with each other.

### SUMMARY OF THE INVENTION

The present invention provides a lockset with one or more door knobs configured to prevent attachment of a noose while enabling secure gripping for ease of unlatching a door.

It is therefore an object to provide a lockset with one or more knobs to which a noose cannot be securely tied.

Another object of the invention is to provide such a lockset with knobs which can be easily gripped and rotated to unlatch a door by a person having limited physical capacity.

A further purpose of the invention is to provide a lockset which can be fitted into a standard door lockset opening while employing exposed knobs to which a noose cannot be securely affixed.

Still a further objective of the invention is to provide a lockset having knobs which are easily gripped but present no surfaces or edges which can cause injury to a person gripping them.

Other and further objects of the invention will be apparent from the following drawings and description of a preferred embodiment of the invention in which like reference numerals are used to identify like parts in the various view.

### DESCRIPTION OF THE DRAWINGS

FIG. 1 is a perspective view of a door unlatching assembly in accordance with the preferred embodiment of the invention shown in its intended environment;

FIG. 2 is an exploded perspective view of the door unlatching assembly shown in FIG. 1;

FIG. 3 is a perspective view of a component of the door unlatching assembly shown in FIGS. 1 and 2;

FIG. 4 is a perspective view of a modified version of the component shown in FIG. 3;

FIG. 5 is a side sectional elevation view of the component shown in FIG. 3.

### DESCRIPTION OF THE PREFERRED EMBODIMENT

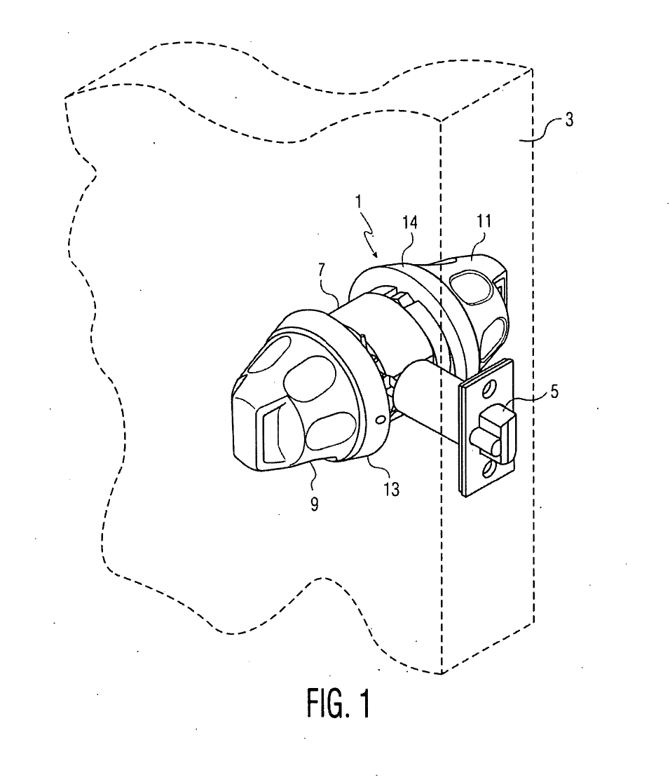

Referring now to FIG. 1 of the drawings, therein shown a lockset 1 for a door 3. The lockset 1 has a conventional latch 5 which is operatively connected to a latch retractor 7 mounted within the door 3. Connected to the latch retractor 7, on each side of the door 3, is a knob 9, 11 mounted on a respective rose 13, 14, that can be rotated for retracting the latch 5 and thereby permitting the door to be opened.

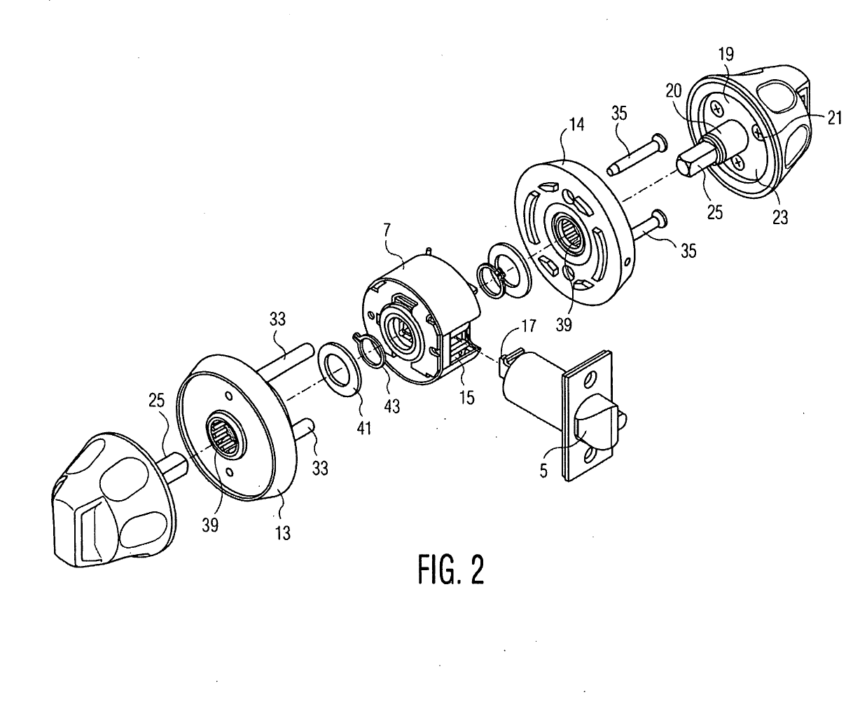

Referring now to FIG. 2 of the drawings, the lockset latch retractor 7 of FIG. 1 is conventional being mountable within a cylindrical opening drilled through the door 3. The latch retractor 7 is provided with lips 15 which grasp a tab 17 on the spring-mounted reciprocating latch 5 as is conventional and will be known to those skilled in the art.

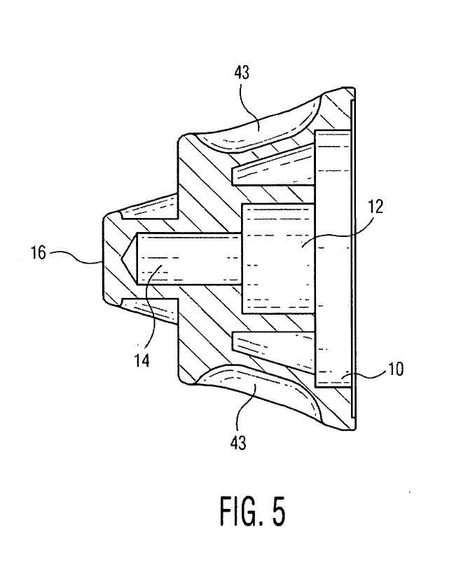

Referring to FIG. 5, each knob, 9, 11 has a stepped central axial blind cylindrical bore with an enlarged portion 10 proximate the base of the knob 9, 11, a narrower axial displaced portion 14 distal from the base of the knob 9, 11, and an intermediate portion 12 disposed between the enlarged portion 10 and the narrower portion 14 of the knob center stepped cylindrical bore.

A knob bushing 19 has a body with circular disc 23 and a central aperture. Extending from each from each side of the disc 23 is a hollow cylindrical boss 20 centered on the disc of the bushing 19. A knob bushing 19 is mounted on each of the knobs 9, 11 by three mounting screws 21.

An end of the cylindrical boss 20 is received in the intermediate portion 12 of the bore while the disc 23 is received in the enlarged portion 10 of the bore. An actuator which is rotatable for causing the latch retractor 7 to unlatch the door is provided in the form of a spindle 25 extending from each knob 9, 11. Each spindle 25 has a driving length with a square cross section and an axially displaced connecting length with a threaded cylindrical portion that is screwed into the end of the cylindrical boss 20 protruding from each of the knob bushings 19 opposite the end received in the intermediate bore portion 12 of the knob 9, 11. When screwed fully into the boss 20 of each knob bushing 19, the spindle extends into the narrower portion 14 of the central bore in each knob 9, 11.

Mounted on respective outer surfaces of the door 3 are the outside rose 13 and an inside rose 14. Two posts 33 with threaded cylindrical bores secure the latch retractor 7 which is sandwiched between the outside rose 13 and inside rose 14. Screws 35, passed through apertures in the inside rose 14 and through the door 3 are received in the hollow threaded cylindrical posts 33 which are affixed to the outside rose 13.

Rotatably mounted within a central cylindrical bore in each of the outside rose 13 and inside rose 14 is a needle roller bearing 39 through which a respective spindle 25 of one of the knobs 9, 11 is passed. Each needle roller bearing is held in place by a washer 41 and retaining ring 43.

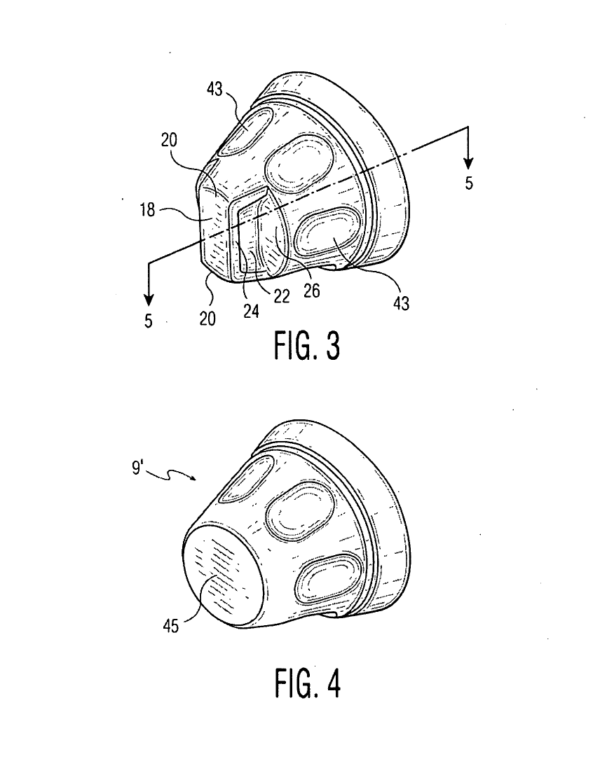

Referring additionally to FIGS. 3 and 5 of the drawings, each knob 9, 11 is generally conical in shape and rotatably mounted with its maximum circumference adjacent its respective rose 13, 14. That is, the maximum diameter of each cross section of each knob transverse to the axis decreases with increasing distance from its base which is mounted on its respective rose 13, 14, adjacent the door 3.

Concavities 43 are equally spaced about a circumference of the tapered conical surface of each knob 9, 11. The concavities 43 preferably have rounded edges. In the preferred embodiment of the invention there are six such concavities. However, the number of concavities can be increased or decreased within the scope of the invention. The circumference of each knob 9, 11 is free of any projections or grooves on or in which a noose could snag when pulled in a direction parallel to or away from the door 3.

The concavities 43 are generally shaped with parallel sides and rounded ends and are sized to accommodate the finger pads of a person in order to enable the knobs to be turned without slipping through the fingers. There are no projections or other raised surfaces on the circumference of each knob 9, 11 to which a noose can be secured.

In accordance with the preferred embodiment of the invention, each of the knobs 9, 11 has at its end distal from its respective rose 13, 14, an integral handle 16 having a rectangular face 18 with ends 20 that meet the tapered surface of the conical knob 9, 11, and trapezoidal recesses 22 on opposite sides of the rectangular handle 16.

The handle 16 may be grasped between the fingers as an alternate way of gripping the knob 9, 11 for rotation in order to unlatch the lockset. A lip 24 surrounds each recesses 22 on three sides. The ends of each lip 24 meet a shoulder 26 having a planar surface orthogonal to the axis of rotation of the knobs 9, 11. Each shoulder 26 serves as a stop for a finger when the handle 16 is grasped for rotating each knob 9, 11. The recesses 22, lips 24, and shoulder 26 allow for a secure grasp of each knob 9, 11, without slippage, for persons who are infirm or otherwise unable to tightly grip the knob 9, 11.

Referring now to FIG. 4 of the drawings, there is shown a knob 9′ similar in shape to the knobs 9, 11 with the following exception. The end 45 of the knob 9′, intended to be distally mounted with respect to the door 3, is truncated and does not have the rectangular handle 16 that is integral with the knobs 9, 11.

Elimination of the rectangular handle enables the knob 9′ to be axially shorter than the knobs 9, 11 with all other dimensions being equal. This can be advantageous for persons with small hands who do not require the use of a handle. The hands can be placed over the front of the knob 9′ with the fingers inserted into the concavities 43 for grasping and rotating the knob 9′.

The knob 9′ is less costly to fabricate than the knobs 9, 11, easier to clean due to fewer recessed surfaces, and may be considered more aesthetically pleasing to the eye.

The knob 9′ may be substituted for either or both of the knobs 9, 11, in accordance with the invention.

It is to be appreciated that the foregoing is a description of a preferred embodiment of the invention to which modifications and variations may be made without departing from the spirit and scope of the invention.

What is claimed is:

1. In a lockset for a door having a latch normally biased toward an extended door locking position, a latch retractor operatively connected to said latch, an actuator operatively connected to said latch retractor for withdrawing said latch toward said retracted door opening position upon rotation thereof, and at least one knob mounted on an end of said actuator for being manually grasped to rotate said actuator about an axis of said knob, the improvement wherein said knob has a generally conical shape, a base end adapted to be mounted on said actuator proximate the surface of said door and an opposite peak end, said knob having an outer circumference which tapers from a maximum at said base end to a minimum at said peak end, the maximum diameter of each cross section of said knob transverse to the axis thereof decreasing with distance from said base end, said knob having a plurality of concavities spaced about said outer circumference.

2. Apparatus according to claim 1 wherein said circumference of said knob is free of projections on which a noose could snag when pulled in a direction parallel to or away from said door.

3. Apparatus according to claim 1 wherein said circumference of said knob is free of grooves in which a noose could snag when pulled in a direction parallel to or away from said door.

4. Apparatus according to claim 1 wherein each of said concavities is shaped to receive a finger pad of a person for gripping said knob for rotation thereof.

5. Apparatus according to claim 4 wherein each of said concavities has two sides with spaced parallel edges and two rounded ends.

6. Apparatus according to claim 1 wherein said concavities are equally spaced about the circumference of said knob.

7. Apparatus according to claim 1 wherein said knob has, proximal its peak end, an integral handle with spaced outward facing symmetrical surfaces parallel to said axis of rotation for being manually grasped to turn said knob.

8. Apparatus according to claim 1 wherein said outward facing symmetrical surfaces are recessed and at least partially surround by a shoulder to prevent slipping of the fingers from the knob when it is pulled.

9. Apparatus according to claim 8 wherein said outward facing symmetrical surfaces are recessed and at least partially surround by a shoulder to prevent slipping of the fingers from the knob when it is pulled.

10. Apparatus according to claim 1 further comprising a second knob mounted on an opposite end of said lockset opposite said one knob, said second knob having a generally conical shape, a base end adapted to be mounted on said actuator proximate the surface of said door and an opposite peak end, said knob having an outer circumference which tapers from a maximum at said base end to a minimum at said peak end, the maximum diameter of each cross section of said knob transverse to the axis thereof decreasing with distance from said base end, said knob having a plurality of concavities spaced about said outer circumference.

11. Apparatus according to claim 10 wherein each of said one knob and said second knob has, proximal its peak end, an integral handle with spaced outward facing symmetrical surfaces parallel to said axis of rotation for being manually grasped to turn said knob.

12. Apparatus according to claim 10 wherein only one of said one knob and said second knob has, proximal its peak end, an integral handle with spaced outward facing symmetrical surfaces parallel to said axis of rotation for being manually grasped to turn said knob.

13. A door knob having an outer conical surface which tapers from a maximum at a base end to a minimum at a peak end, the maximum diameter of each cross section of said knob transverse to the axis thereof decreasing with distance from said base end, said knob having a plurality of concavities spaced about a circumference of said conical surface.

14. Apparatus according to claim 13 wherein said conical surface of said knob is free of projections on which a noose could snag when pulled in a direction parallel to or away from an axis of rotation of said knob.

15. Apparatus according to claim 13 wherein said circumference of said knob is free of grooves in which a noose could snag when pulled in a direction parallel to or away from said door.

16. Apparatus according to claim 13 wherein each of said concavities is shaped to receive a finger pad of a person for gripping said knob for rotation thereof.

17. Apparatus according to claim 13 wherein each of said concavities has two sides with spaced parallel edges and two rounded ends.

18. Apparatus according to claim 13 wherein said concavities are equally spaced about the circumference of said knob.

19. Apparatus according to claim 13 wherein said knob has, proximal its peak end, an integral handle with spaced outward facing symmetrical surfaces parallel to said axis of rotation for being manually grasped to turn said knob.
